(19) United States
(12) Patent Application Publication
(10) Pub. No.: US 2006/0075015 A1
(43) Pub. Date: Apr. 6, 2006

(54) Control point filtering

(75) Inventors: Tao Wu, Woburn, MA (US); Sadhna Ahuja, Waltham, MA (US); Yinghua Ye, Woburn, MA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/956,545

(22) Filed: Oct. 1, 2004

(51) Int. Cl. G06F 15/16

(52) U.S. Cl. 709/202; 709/246

(57) ABSTRACT

A universal plug and play (UPnP) control point includes a memory and a system for selecting a first user profile. The memory includes multiple user profiles. A first one of the profiles includes content filter information. The system for selecting the first user profile is for use by the UPnP control point, and automatically selectively prevents display of content on a MediaRenderer from a MediaServer based upon the content filter information in the first user profile.

### BACKGROUND OF THE INVENTION

1. Field of the Invention

The present invention relates to filtering of content and, more particularly, to a filter which can be selected based upon a selected profile in a portable electronic device.

2. Brief Description of Prior Developments

Universal Plug and Play (UPnP) is a networking architecture. UPnP™ technology is making home networking simple and affordable for users so the connected home experience becomes a mainstream experience for user experience and great opportunity for the industry. UPnP™ architecture offers pervasive peer-to-peer network connectivity of PCs of all form factors, intelligent appliances, and wireless devices. UPnP™ architecture leverages TCP/IP and the Web to enable seamless proximity networking in addition to control and data transfer among networked devices in the home, office, and everywhere in between. UPnP™ technology can be supported on essentially any operating system and works with essentially any type of physical networking media—wired or wireless—providing maximum user and developer choice and great economics.

The UPnP™ Forum (www.upnp.org) is an industry initiative designed to enable simple and robust connectivity among stand-alone devices and PCs from many different vendors. The Forum consists of more than 700 vendors, including industry leaders in consumer electronics, computing, home automation, home security, appliances, printing, photography, computer networking, and mobile products. By defining and publishing UPnP™ device and service descriptions, members of the UPnP™ Forum are creating the means to easily connect devices and simplify the implementation of networks. UPnP™ technology is broad in scope in that it targets home networks, proximity networks, and networks in small businesses and commercial buildings. It enables data communication between any two devices under the command of any control device on the network. UPnP™ technology is independent of any particular operating system, programming language, or physical medium.

The UPnP™ architecture supports zero-configuration networking and automatic discovery whereby a device can dynamically join a network, obtain an IP address, announce its name, convey its capabilities upon request, and learn about the presence and capabilities of other devices. DHCP and DNS servers are optional and are only used if they are available on the network. A device can leave a network smoothly and automatically without leaving any unwanted state information behind.

Like the creation of Internet standards, the UPnP™ initiative involves a multi-vendor collaboration for establishing standard Device Control Protocols (DCPs). Similar to Internet-based communication, these are contracts based on wire protocols that are declarative, expressed in XML, and communicated via HTTP.

The Digital Home Working Group (DHWG), now known as the Digital Living Network Alliance (DLNA), is a non-profit organization dedicated to the simplified sharing of digital content, such as digital music, photos and video, among networked consumer electronics (CE), mobile devices and PCs. The group consists of industry leaders including Fujitsu, Gateway, HP, Intel, IBM, Kenwood, Lenovo, Matsushita Electric (Panasonic), Microsoft, NEC CustomTechnica, Nokia, Philips, Samsung, Sharp, Sony, STMicroelectronics and Thomson.

The group shares a common goal of establishing a platform of interoperability based on open industry standards and will deliver technical design guidelines that companies can use to develop digital home products that share content through wired or wireless networks in the home. Examples of these products include PCs, TVs, set-top boxes, printers, stereos, mobile phones, PDAs, DVD players, digital projectors and other devices.

Due in large to an increase in broadband adoption and device sales, consumers today are acquiring, viewing, managing and sharing an increasing amount of digital media on devices in the CE, mobile and PC domains. As such, consumers want to easily enjoy this content, regardless of the source, across different devices and locations in the home. A number of conflicting standards and media formats exist today making the digital home complex to set-up and manage.

Industry standards alone do not always ensure interoperability. The interoperability framework and technical design guidelines established by the DHWG will provide the baseline for development of multi-branded products and solutions that will work better together. The goal of the group is to deliver guidelines resulting in the first compliant products within the next 12 months.

This collection of cross-industry leaders share a common vision and are collaborating to make the connected home a reality. One of the critical requirements for mass-market success of networked devices is true and reliable interoperability. The Digital Home Working Group has proposed a sound and fair baseline of interoperability standards, which is an important milestone towards realizing this vision.

The DHWG design guidelines will utilize well-known and established standards such as Internet Protocol (IP), UPnP™, Wi-Fi™, and other common formats. Over time, the guidelines will evolve to incorporate emerging or subsequent versions of existing standards. Format interoperability will be achieved by requiring certain formats that meet specific criteria. The format will be an open standard that has been formally ratified by an internationally recognized standards organization, and IP will be licensed under reasonable, non-discriminatory terms.

In the emerging digital home environment, users often share with each other multimedia content. As an example, parents would sit together with their children, browse and search multimedia content stored in different home electronic devices (set-top boxes, PCs, etc), and choose a family movie to watch together. They typically use a portable device (remote control or mobile phone) to browse or search for content, and the search result may be displayed on a large display (e.g., TV) for everyone to see. In addition, brief introduction or thumbnail images of browsed/searched content may be shown on the display to allow better user experience by using remote I/O technology which is developed in UPnP Forum. In UPnP terminology, the devices that store content are called MediaServers, the devices that render the content are called MediaRenderers, and the device that serves as control point's I/O are called remote I/O (or UI) client. As an example, an UPnP-enabled TV can act as both MediaRenderer and remote display client. The controlling device that a user uses to search/browse content and control MediaServers and MediaRenderers is called the Control Point.

A problem arises when inappropriate content (such as violent or adult content for example) is shown on the MediaRenderer that children are watching. For the same reason, embarrassment may also arise when browsing/searching for content to share with a guest. This problem may result from browsing a content directory that stores both desired and inappropriate content. It could also happen because the inappropriate content inadvertently matches the search criteria set by the user.

### SUMMARY OF THE INVENTION

In accordance with one aspect of the present invention, a universal plug and play (UPnP) control point is provided which includes a memory and a system for selecting a first user profile. The memory includes multiple user profiles. A first one of the profiles includes content filter information. The system for selecting the first user profile is for use by the UPnP control point, and automatically selectively prevents display of images on a MediaRenderer from a MediaServer based upon the content filter information in the first user profile.

In accordance with another aspect of the present invention, a system for displaying images on a MediaRenderer from a MediaServer is provided comprising a system for determining location of a universal plug and play (UPnP) control point; a system for selecting a user profile in the control point based upon the determined location of the control point; and a system for filtering the display of the images based upon control filter information of the selected user profile in the control point.

In accordance with another aspect of the present invention, a system for displaying images on a MediaRenderer is provided comprising a universal plug and play (UPnP) control point having control filter information for selectively preventing display of images on the MediaRenderer; and a system for displaying at least a portion of the images on the control point while the images are prevented from being displayed on the MediaRenderer.

In accordance with another aspect of the present invention, a system for displaying images on a MediaRenderer is provided comprising a universal plug and play (UPnP) control point having a user selectable content filter; and a content filter transmitter for automatically setting the content filter to a predetermined content filter setting based at least partially upon proximity of the control point to the content filter transmitter.

In accordance with one method of the present invention, a method for preventing display of images on a MediaRenderer is provided comprising selecting a first profile from a plurality of profiles in a universal plug and play (UPnP) control point, the first profile comprising content filter information; and preventing display of images on the MediaRenderer based at least partially upon the content filter information of the selected first profile in the control point.

### BRIEF DESCRIPTION OF THE DRAWINGS

The foregoing aspects and other features of the present invention are explained in the following description, taken in connection with the accompanying drawings, wherein:

FIG. 1 is a diagram of a system incorporation features of the present invention;

FIG. 2 is a diagram showing components of the system shown in FIG. 1;

FIG. 3 is a perspective view of the control point mobile telephone shown in FIG. 2;

FIG. 4 is a block diagram of some of the components of the control point mobile telephone shown in FIG. 3;

FIG. 5 is block diagram of some of the features in the memory of the control point mobile telephone shown in FIG. 4;

FIG. 6 is a block diagram of some of the features in one of the profiles shown in FIG. 5;

FIG. 7 is a block diagram of steps using features of the present invention;

FIG. 8 is a block diagram of steps using features of the present invention;

FIG. 9 is a diagram showing use of the control point mobile telephone as a Remote I/O Server and use of the MediaRenderer as a Remote I/O Client;

FIG. 10 is a block diagram of steps used in an alternate embodiment of the present invention;

FIG. 11 is a block diagram of setting in the content filter rules shown in FIG. 6; and

FIG. 12 is a block diagram of additional or alternative steps using features of the present invention.

### DETAILED DESCRIPTION OF THE PREFERRED EMBODIMENTS

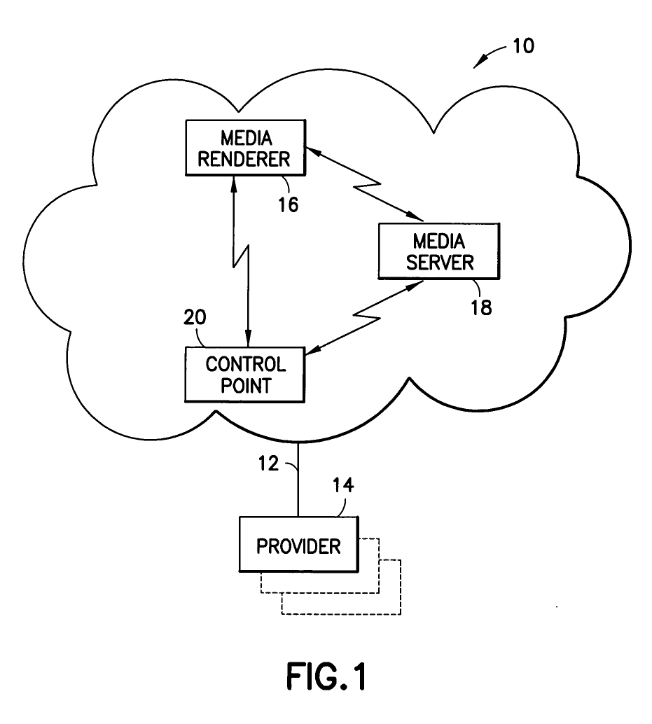

Referring to FIG. 1, there is shown a diagram of a system 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

The system 10 shown in FIG. 1 comprises a home entertainment system which is connected by a connection 12 to one or more providers 14. The home entertainment system 10 generally comprises a Universal Plug and Play (UPnP) MediaRenderer 16, a UPnP MediaServer 18 and a UPnP control point 20.

The provider(s) 14 could comprise any suitable type of provider, such as a cable television provider, a satellite television provider, and/or an Internet entertainment provider, for example. The connection 12 could comprise any suitable type of connection including, for example, a cable connection, a satellite connection, a telephone line connection, a DSL line connection, and/or a wireless connection through a mobile telephone network. Although the present invention is being described in a home entertainment system, features of the present invention could be incorporated into a mobile entertainment system, such as in a vehicle, or any other suitable type of system which comprises a UPnP MediaRenderer, UPnP MediaServer, and UPnP control point. In alternate embodiments, any suitable type of networking architecture could be used so long as the components function similar to the UPnP MediaRenderer, UPnP MediaServer, and UPnP control point described herein. In the home entertainment system shown in FIG. 1, the MediaRenderer could comprise a television set or computer monitor, the MediaServer can comprise a provider control box, such as a cable receiver box or satellite receiver box, for example. In the embodiment shown, the control point 20 preferably comprises a portable telephone and/or a mobile gaming device, such as a Nokia N-Gage™ device.

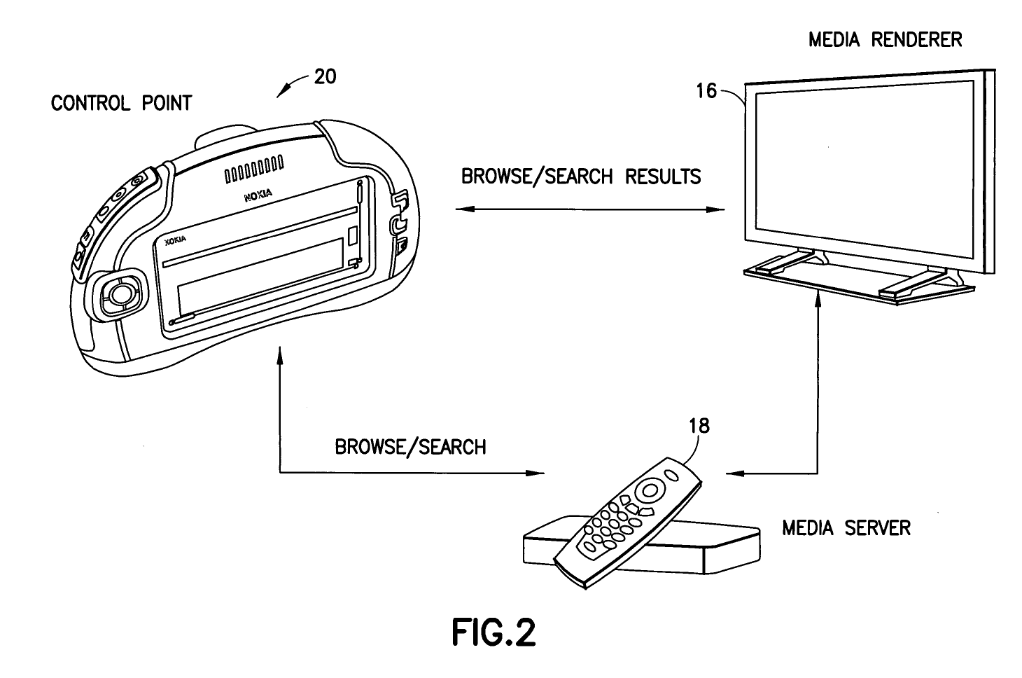

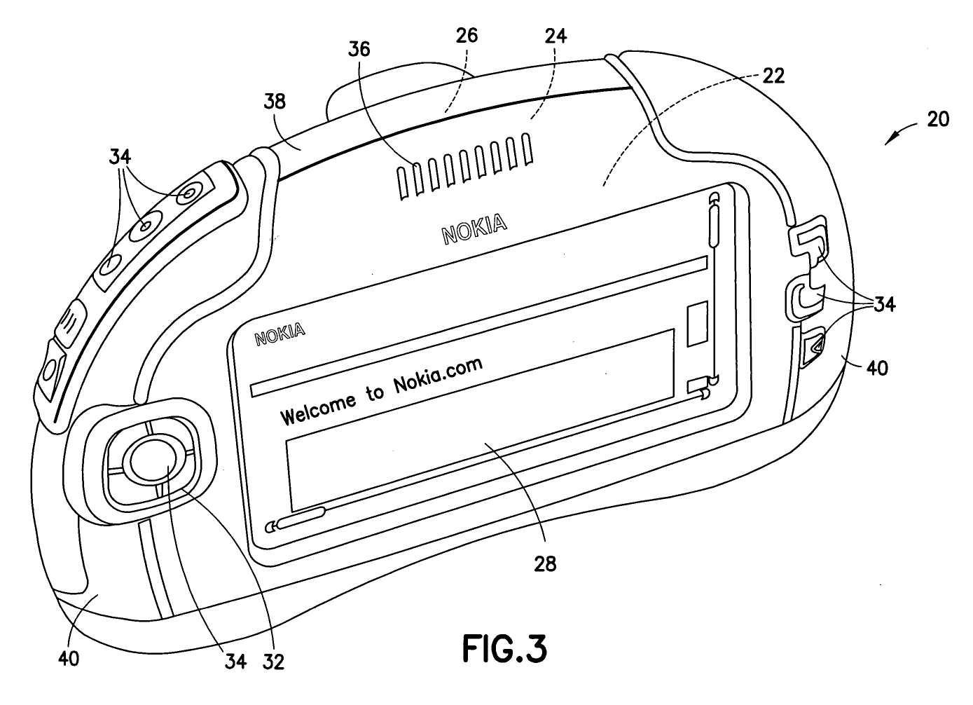

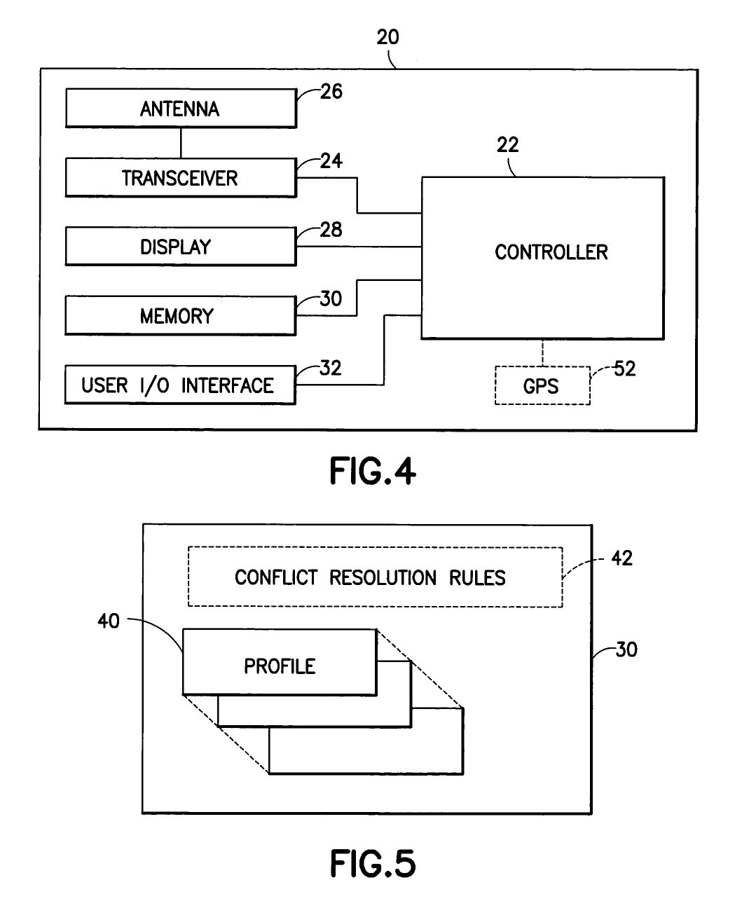

Referring also to FIG. 2, the control point 20 can be used by a user to browse or search available media content accessible through the MediaServer 18 for display on the MediaRenderer 16. Referring also to FIGS. 3 and 4, the control point 20 generally comprises a controller 22, a transceiver 24 connected to an antenna 26, a display 28, a memory 30, and a user I/O interface 32. In the embodiment shown, the user I/O interface 32 comprises telephone buttons 34 including alphanumeric keys (not shown) located on the reverse side of the side shown in FIG. 3, direction/navigation/selection keys 34, and a speaker 36. The housing 38 is adapted to be held by a user with two hands; one hand at each opposite side end 40 wherein the users thumbs can be used to actuate the keys 34 without obscuring images on the display 28. In alternate embodiments, any suitable shape or structure could be provided. The control point 20 comprises other features, such as a rechargeable battery, which is conventional to mobile telephones. The control point 20 could also comprise a digital camera or video camera. As noted above, the control point 20 comprises a mobile telephone which is adapted to communicate via a wireless link and the transceiver 24 and antenna 26 to a mobile telephone communications system (not shown).

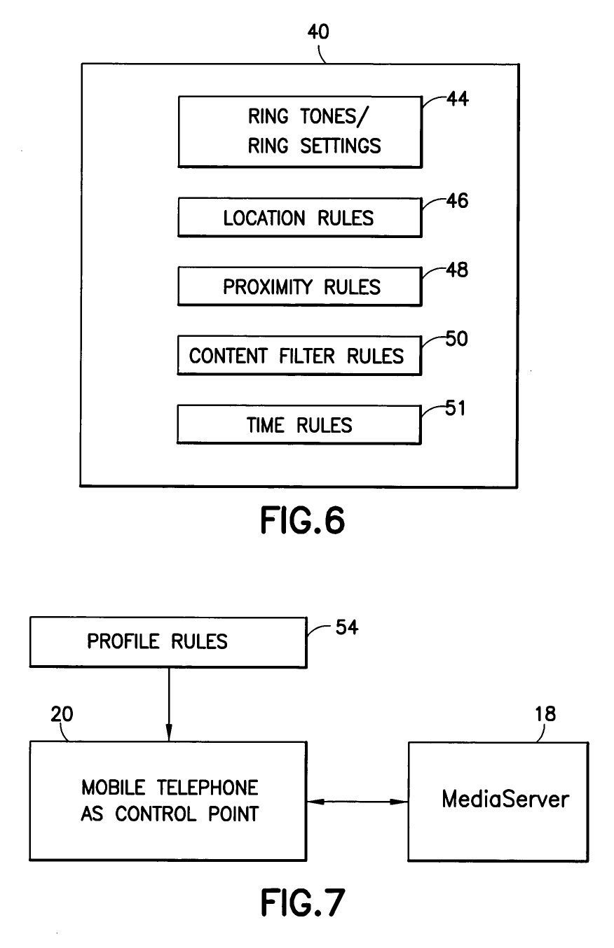

Referring also to FIGS. 5-6, the memory 30 comprises, among other things conventional to a mobile telephone and/or a gaming device, at least one profile 40. Profiles have been used in mobile telephones in the past. Specifically, a user can set up one or more profiles to set or change one or more telephone features (ring tones, automatic answering, ring volume, etc) by merely switching among profiles. With the present invention, each profile 40, in addition to telephone feature setting, can also comprise settings or rules for various non-telephone applications. The profile 40 can contain user selected preferences for various applications such as, for example, ring tones or ring settings 44, location rules 46, proximity rules 48, content filter rules 50, and time rules 51.

For example, a first profile could comprise settings for the control point for use while the user is in a home environment, a second profile could comprise settings for the control point for use while the user is driving in a vehicle, a third profile could comprise settings for the control point for use while the user is an office environment or a classroom environment, a fourth profile could comprise settings for the control point for use while the user is in a meeting, etc. The location rules 46 could be used in conjunction with location determination by a location system such as a GPS locator 52 shown in FIG. 4. For example, CDMA telephones have a GPS receiver. The proximity rules 48 could be used in conjunction with a determined location of another electronic device, such as one or more mobile telephones, or a home computer, or an office computer, or a home entertainment system, for example. U.S. Pat. No. 6,198,783 discloses a geographic relationship method which includes two mobile units for determining their respective locations. The content filter rules 50 can be used to filter display or other playing of media information from the MediaServer 18 on the MediaRenderer 16. The content filter information can comprise fixed rules and/or user configurable rules. The memory 30 could also comprise conflict resolution rules 42 for use as further described below. The profile can also be based on information other than location. For example, one could set the rule that “switch to family profile everyday from 7 PM to 8 PM”. In this case the rules/profiles are based on time.

As noted above, a problem arises when inappropriate content (such as violent or adult content for example) is shown on the MediaRenderer that children are watching. For the same reason, embarrassment may also arise when browsing/searching for content while children are present or to share with a guest. This problem may result from browsing a content directory that stores both desired content and inappropriate content. During searching, rather than browsing, it could also happen because the inappropriate content matches the search criteria set by the user.

The present invention uses profile information in the mobile telephone to avoid the problem described above. With the present invention a mobile phone can be used as the control point used to browse/search for content. The mobile telephone 20, acting as the control point, is adapted to allow a user to select one of the profiles 40 for use of its content filter rules (and any content filter application(s)) by the control point. Thus, the present invention can comprise a system for selecting the user profile comprising a manually selectable system at a user interface of the control point. The system for selecting the user profile comprises a receiver of the control point adapted for receiving a user profile selection signal from another device. The system for selecting the user profile could comprises a system for automatically selecting the user profile based upon location of the control point, such as relative to another mobile telephone or relative to a geographic location, such as determined by a global positioning system (GPS) device in the control point. For example, the mobile telephone may have a “family” profile (or other similar profile) that indicates that the user is at home or children might be present. When such profile is in use, the telephone 20 (functioning as the control point) filters the browsed/searched content list so that inappropriate content is not shown on the display 16.

It is possible for the phone 20 to use other methods to infer that children or guests are present. For example, if the phone detects the presence or proximity of mobile phones owned by children or unknown people (such as by examining the identification obtained from Bluetooth for example), it can perform similar filtering.

The present invention should be straightforward to implement on DLNA-compliant mobile phones. Such phones will support UPnP A/V Browse and Search actions, and can check related metadata field of the content, returned by UPnP A/V MediaServers. Especially, a UPnP A/V MediaServer may support the “rating” metadata, which may carry MPAA (Motion Picture Association of America) rating of the content. The mobile phone that implements the invention could check the profile and other information. If it decides that the user is sharing content with children or guests (e.g., the current profile is “Family”), it can remove all content items rated “R” or “X” and display the remaining content items on the display. For television programs, the programs can carry TV Parental Guidelines (such as used by V-chips in television sets) of TVY, TVY7, TVY7FU, TVG, TVPG, TV14, TVMA which can be used by the control point 20 for filtering during browse/search and/or viewing of the program(s).

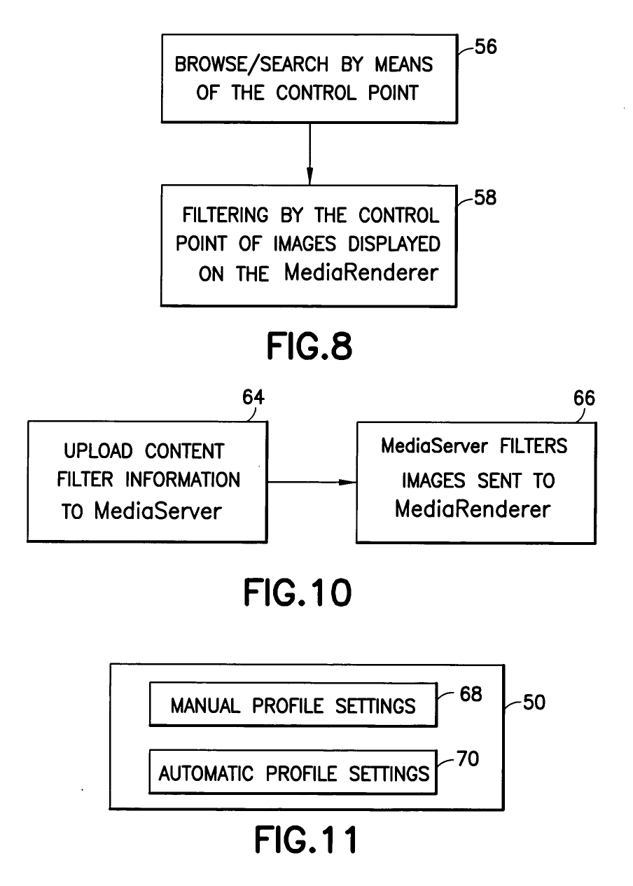

FIG. 7 illustrates one possible implementation of the invention, where search results are filtered based on phone profile. For example, when the phone is on “Family” profile, only movies with “PG-13” or “G” ratings will be shown in the search results. Profile rules 54 can be loaded into the mobile telephone 20 and the telephone 20 can communicate with the MediaServer 18. Referring also to FIG. 8, as indicated by block 56 browsing and/or searching can be provided by the mobile telephone as the control point. As indicated by block 58 the mobile telephone as the control point can filter browse images or search images displayed on the MediaRenderer, such as blocking display of images and/or sound, or substituting other images and/or sounds.

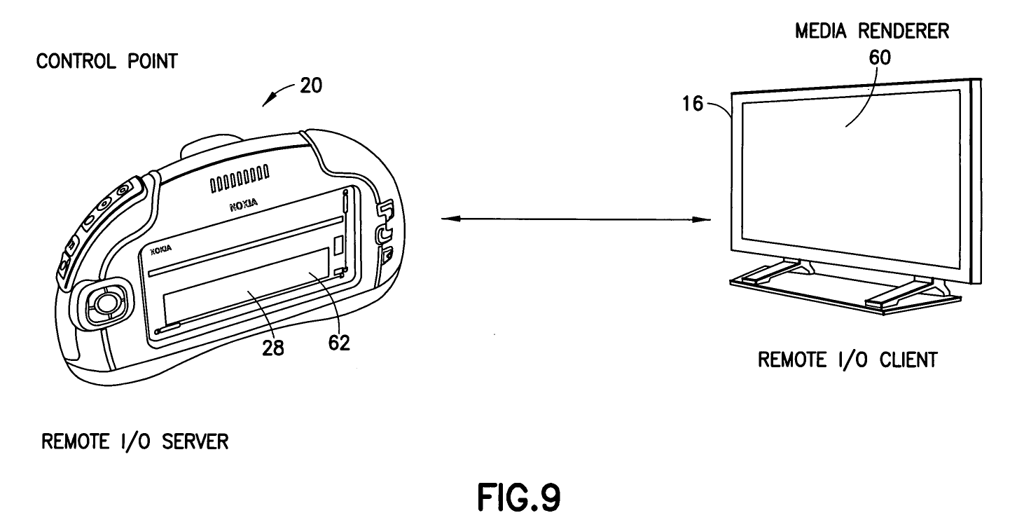

Referring also to FIG. 9, if UPnP Remote I/O is used, one could also implement the invention so that the display on the MediaRenderer 16 as the Remote I/O Client shows filtered search results or a substitute image 60, and the Control Point 20 as the Remote I/O Server shows original search results 62 on its own display 28. FIG. 2 illustrates different UPnP A/V components. Thus, it is also possible to further enhance the invention by showing different search/browse results on the private display 28 on Control Point 20 versus the search/browse results which are shown on the public display of the MediaRenderer 16 at the same time. In this case, the control point can send filtered search results to display on MediaRenderer based on profile setting. Here, the MediaRenderer is the Client in an architecture called UPnP Remote I/O, also being developed in the UPnP Forum. In UPnP Remote I/O, a Server (Control Point in this embodiment) controls what to be displayed in the Client (MediaRenderer in this embodiment). The Server can also have its own display, which is independent from the display on the Client.

Referring also to FIG. 10, the present invention can additionally or alternatively comprise uploading of the content filter information from the mobile telephone 20 to the MediaServer as indicated by block 64. This uploaded content filter information can then be used by the MediaServer to filter images sent to the MediaRenderer as indicated by block 66. The filtered images could be browse/search images and/or full program images/sounds. This uploading 64 could be done automatically such as when a mobile telephone of a child comes into proximity of the MediaServer, the content filter information from the child's mobile telephone could be automatically uploaded to the MediaServer, thereby automatically setting the MediaServer filter for appropriate filtering suitable for the child. Alternatively, the content filter information could be established in a parent's mobile telephone and uploaded by the parent to the MediaServer for continuous use unless the parent selects a different temporary override profile in his or her telephone.

Referring also to FIG. 11, creation of the content filter rules could comprise only manually input profile settings 68, or only automatically input profile setting 70, or a combination of user manually input profile settings 68 and automatically input profile settings 70. The user manually input profile settings 68 can be input by the user with the I/O interface on the mobile telephone 20.

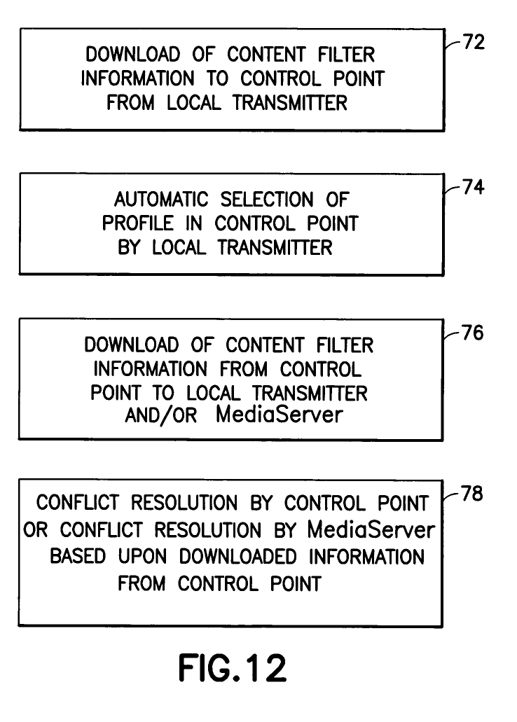

Referring also to FIG. 12 several variations or options for use with the present invention are shown. As illustrated by block 72, the automatically input profile settings 70 shown in FIG. 11 can comprise content filter information which is uploaded to the mobile telephone 20 from another local electronic device, such as the MediaServer or a home computer for example. Thus, the MediaServer can function as a local content filter transmitter for uploading content filter information to the control point for subsequent use during browsing and/or searching in proximity of the local content filter transmitter, or perhaps to configure a user's telephone with a profile setting for continuous or permanent use, such as a child's mobile telephone.

The system 10 could be configured such that a profile is automatically selected in the control point by the local transmitter as indicated by block 74. Alternatively, the profile could be automatically selected or changed by the control point based upon other parameters, such as geographic location of the mobile telephone (such as determined by a GPS receiver 52 (see FIG. 4)), or location of another predetermined mobile telephone relative to the control point (such as a child's mobile telephone). As indicated by block 76, the content filter information or a profile can be downloaded from the mobile telephone to a local transmitter and/or the MediaServer for use in transmitting to other mobile telephones (or other control points) and/or for use by the MediaServer for filtering browsing/searching/playing of program or entertainment signals.

As indicated by block 78 the control point and/or the MediaServer can comprise a conflict resolution for resolving conflicts in the content filter information downloaded from the control point, such as with use of conflict resolution rules 42 shown in FIG. 5. Thus, any conflicts could be resolved by the control point or could optionally be resolved by the MediaServer based upon which system is giving priority.

Although the present invention is primarily described with a media server which receives media content from one or more remote providers 14, features of the present invention could also be used with a MediaServer or UPnP remote I/O server, such as a DVD player, which can read content coded portions with different parental guideline codes or movie ratings codes on a DVD. For example, a DVD could be provided of a movie wherein violent portions of the movie are rated with a violence rating which can be read by the DVD player. This portion rating can be used for subsequent filtering or blocking of only that portion of the movie. Thus, an R rated movie could be watched by the entire family with violent portions automatically filtered or blocked; and perhaps automatically fast forwarded through by the DVD player. The same type of partial content filtering can be used with other parameters, such as adult language, nudity, adult situations, etc. The present invention can also be used in cases where there is no concept of profile. In these scenarios, content filtering is done based on rules about internal or external events or conditions.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A universal plug and play (UPnP) control point comprising:
a memory comprising user profiles, a first one of the profiles comprising content filter information; and
a system for selecting the first user profile for use by the UPnP control point and automatically selectively preventing display of content on a MediaRenderer from a MediaServer based upon the content filter information in the first user profile.

2. A universal plug and play (UPnP) control point as in claim 1 wherein the UPnP control point comprises a mobile telephone.

3. A universal plug and play (UPnP) control point as in claim 1 wherein the UPnP control point comprises a hand-held wireless gaming device.

4. A universal plug and play (UPnP) control point as in claim 1 wherein the system for selecting the first user profile comprises a manually selectable system at a user interface of the control point.

5. A universal plug and play (UPnP) control point as in claim 1 wherein the system for selecting the first user profile comprises a receiver adapted for receiving a user profile selection signal from another device.

6. A universal plug and play (UPnP) control point as in claim 1 wherein the system for selecting the first user profile comprises a system for automatically selecting the first user profile based upon location of the control point.

7. A universal plug and play (UPnP) control point as in claim 6 wherein the system for automatically selecting the first user profile is based upon location of the control point relative to a mobile telephone.

8. A universal plug and play (UPnP) control point as in claim 6 wherein the system for automatically selecting the first user profile is based upon location of the control point relative to a geographic location determined by a global positioning system (GPS) device in the control point.

9. A universal plug and play (UPnP) control point as in claim 1 wherein the control point is adapted to send the content filter information of the first user profile to the MediaServer.

10. A universal plug and play (UPnP) control point as in claim 1 wherein signals of the content are sent to the control point before being sent to the MediaRenderer.

11. A universal plug and play (UPnP) control point as in claim 1 wherein the content filter information comprises a selected maximum guideline rating from a plurality of predetermined TV Parental Guidelines or movie ratings.

12. A universal plug and play (UPnP) control point as in claim 1 further comprising a system for displaying at least a portion of the content on the control point while the content is prevented from being displayed on the MediaRenderer.

13. A universal plug and play (UPnP) control point as in claim 1 further comprising a system for receiving content filter information from a local content filter transmitter and using the received content filter information to automatically selectively prevent display of content on the MediaRenderer.

14. A universal plug and play (UPnP) control point as in claim 13 further comprising a system for resolving a conflict between the content filter information in the first user profile and the content filter information received from the local content filter transmitter.

15. A universal plug and play (UPnP) control point as in claim 1 further comprising a system for uploading the content filter information to a local global content filter transmitter.

16. A universal plug and play (UPnP) control point as in claim 1 wherein the content filter information comprises fixed rules.

17. A universal plug and play (UPnP) control point as in claim 1 wherein the content filter information comprises user configurable rules.

18. A universal plug and play (UPnP) control point as in claim 1 wherein the content filter information comprises time rules.

19. A system for displaying content on a MediaRenderer from a MediaServer comprising:
a system for determining location of a universal plug and play (UPnP) control point;
a system for selecting a user profile in the control point based upon the determined location of the control point; and
a system for filtering the display of the content based upon control filter information of the selected user profile in the control point.

20. A system for displaying content on a MediaRenderer from a MediaServer as in claim 19 wherein the system for determining location of the control point comprises a global positioning system (GPS) device.

21. A system for displaying content on a MediaRenderer from a MediaServer as in claim 19 wherein the system for determining location of the control point is adapted to determine location of the control point relative to a mobile telephone.

22. A system for displaying content on a MediaRenderer from a MediaServer as in claim 19 wherein the UPnP control point comprises a mobile telephone.

23. A system for displaying content on a MediaRenderer from a MediaServer as in claim 19 wherein the UPnP control point comprises a hand-held wireless gaming device.

24. A system for displaying content on a MediaRenderer from a MediaServer as in claim 19 wherein the UPnP control point further comprises a system for selecting a first user profile from a plurality of user profiles, and the system for selecting comprises a manually selectable system at a user interface of the control point.

25. A system for displaying content on a MediaRenderer from a MediaServer as in claim 24 wherein the system for selecting the first user profile comprises a receiver adapted for receiving a user profile selection signal from another device.

26. A system for displaying content on a MediaRenderer from a MediaServer as in claim 19 wherein the control point is adapted to send the content filter information of the first user profile to the MediaServer.

27. A system for displaying content on a MediaRenderer from a MediaServer as in claim 19 wherein signals of the content are sent to the control point before being sent to the MediaRenderer.

28. A system for displaying content on a MediaRenderer from a MediaServer as in claim 19 wherein the content filter information comprises a selected maximum guideline rating from a plurality of predetermined TV Parental Guidelines or movie ratings.

29. A system for displaying content on a MediaRenderer from a MediaServer as in claim 19 further comprising a system for displaying at least a portion of the content on the control point while the content is prevented from being displayed on the MediaRenderer.

30. A system for displaying content on a MediaRenderer from a MediaServer as in claim 19 further comprising a system for receiving content filter information from a local content filter transmitter and using the received content filter information to automatically selectively prevent display of content on the MediaRenderer.

31. A system for displaying content on a MediaRenderer from a MediaServer as in claim 30 further comprising a system for resolving a conflict between the content filter information in the selected user profile and the content filter information received from the local content filter transmitter.

32. A system for displaying content on a MediaRenderer from a MediaServer as in claim 19 wherein the UPnP control point further comprises a system for uploading the content filter information to a local global content filter transmitter.

33. A system for displaying content on a MediaRenderer from a MediaServer as in claim 19 wherein the content filter information comprises fixed rules.

34. A system for displaying content on a MediaRenderer from a MediaServer as in claim 19 wherein the content filter information comprises user configurable rules.

35. A system for displaying content on a MediaRenderer comprising:
a universal plug and play (UPnP) control point having control filter information for selectively preventing display of content on the MediaRenderer; and
a system for displaying at least a portion of the content on the control point while the content is prevented from being displayed on the MediaRenderer.

36. A system for displaying content on a MediaRenderer comprising:
a universal plug and play (UPnP) control point having a user selectable content filter; and
a content filter transmitter for automatically setting the content filter to a predetermined content filter setting based at least partially upon proximity of the control point to the content filter transmitter.

37. A universal plug and play (UPnP) control point comprising:
a memory comprising a plurality of user profiles, a first one of the profiles comprising UPnP content filter information; and
a system for selectively preventing display of at least one predetermined type of browsed result information and/or search result information on a MediaRenderer from a MediaServer during browsing and/or searching with the control point based, at least partially, upon the content filter information in the first user profile while the first profile is in use by the control point.

38. A method for preventing display of content on a MediaRenderer comprising:
selecting a first profile from a plurality of profiles in a universal plug and play (UPnP) control point, the first profile comprising content filter information; and
preventing display of content on the MediaRenderer based at least partially upon the content filter information of the selected first profile in the control point.

39. A method as in claim 38 further comprising displaying the content on the UPnP control point while the content are prevented from being displayed on the MediaRenderer.

40. A method as in claim 38 wherein the step of selecting the first profile comprises automatically selecting the first profile based upon location of the control point.

41. A method as in claim 40 wherein the step of selecting the first profile is based upon geographic location of the control point.

42. A method as in claim 40 wherein the step of selecting the first profile is based upon location of the control point relative to a mobile telephone.

43. A method as in claim 40 wherein the step of selecting the first profile is based upon location of the control point relative to a home electronics device.

44. A method as in claim 40 wherein the home electronics device comprises a home computer or home entertainment center.
